(19) United States
(12) Patent Application Publication
(10) Pub. No.: US 2003/0156411 A1
(43) Pub. Date: Aug. 21, 2003

(54) Light systems and light fixtures for use with light strings

(76) Inventor: Joseph M. Ahroni, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/077,688

(22) Filed: Feb. 15, 2002

(51) Int. Cl. F21V 21/00

(52) U.S. Cl. 362/249

(57) ABSTRACT

A light system with a light fixture includes a central member with a plurality of elongated members coupled thereto, extending radially outward from the central member in a plurality of planes. Each elongated member is configured to retain a plurality of parallel light strings routed to the elongated member from within an internal cavity of the central member.

### BACKGROUND OF THE INVENTION

1. Field of the Invention

The following invention relates to decorative light systems and light fixtures for use with light strings.

2. Description of the Related Art

Decorative light arrangements are highly popular in the United States, such as, for example, during November and December, in celebration of Christmas. Indeed, it is reasonable to say that most, if not all Americans, have used decorative lights, or seen them aglow in numerous decorative light arrangements in all sorts of settings.

As technology has improved in the area of decorative lighting, their use has expanded. The breadth of available products has increased correspondingly and manufacturers and users have become more creative in making and employing decorative light arrangements. However, technological limitations still present problems in reliability and ease of use in many of these decorative lighting arrangements.

One example of a decorative lighting arrangement is a “firework,” incorporating elongated light tubes extending from a single node in a plurality of directions. The light tubes are colored to make the clear lights in the tube appear red, blue, or another color. However, such a lighting device has a number of disadvantages. For example, the entire light tube is made of a translucent, colored material that encases light bulbs therewithin. If a light bulb bums out, replacing the bulb requires removing or replacing the entire tube. Similarly, the use of translucent tubes requires all of the lights in a given tube to appear the same color. Also, the tubes are configured to plug into the node and the interface between the tubes and node must be kept dry, which is difficult in outdoor use.

There is a need for a light system that provides the aesthetic appeal of simulated stars, fireworks, or sparklers, but without many of the problems associated with the prior art.

### BRIEF SUMMARY OF THE INVENTION

One embodiment of the present invention includes a light system with a light fixture to retain light strings in a spatial arrangement reminiscent of a star or explosion, with strings of lights extending linearly from a central node in a plurality of directions in multiple planes. The light fixture includes a central member having an internal cavity for retaining a light string controller. The central member also has plurality of wire-ways through which light strings can be routed from the internal cavity, out of the central member, and from an exterior of the central member, back into its internal cavity. A plurality of elongated members is coupled to the central member in a plurality of non-planar radial directions, with openings on proximal ends thereof facing the wire-ways. Wiring for light strings routed through the wire-ways of the central member can be routed directly into and out of the elongated members through the proximal end openings thereof, and can be extendedly retained in the elongated members to achieve the spatial arrangements described above.

Each elongated member also has an elongated opening along its length through which bulbs of the light strings can project or protrude from the elongated member. The light strings are retained within the elongated member with the bulbs arranged in a row along the length of the elongated opening, with each bulb projecting from the elongated opening.

In some embodiments of the light system, parallel light strings are routed from an internal cavity of the central member, out through the wire-ways, and back into the central member, repeatedly through a plurality of wire-ways, with a portion of each light string extending out of each wire-way. The portions of light strings extending out of each wire-way are tied, clipped, or otherwise bound, together to form a light bundle, such that a light bundle extends from each wire-way. The bulbs from each light string occupy a distinct position along the length of each of the light bundles, the position being repeated in each light bundle of which the respective light string is a part. With this configuration, controlling power to sequentially illuminate the parallel light strings can control the sequential order of lighting along the length of the light bundle.

The light bundle is retained in the elongated members in the same way described above for light strings, and the sequential control of the lighting along the length of the light bundle can enhance the effect that the light system has in simulating rays, explosions, or light propagating outward from a node.

### BRIEF DESCRIPTION OF SEVERAL VIEWS OF THE DRAWING(S)

FIG. 1 is a perspective view of a decorative lighting assembly according to an embodiment of the present invention.

FIG. 2 is an exploded view of the one of the retainer arms of the assembly of FIG. 1, showing one light bundle and one retainer arm, as well as a portion of the sphere to which the retainer arm can be coupled.

FIG. 3 is an elevation view of the sphere from the assembly of FIG. 1.

FIG. 4 is an exploded side view of the sphere and a mounting rod from the assembly of FIG. 1.

FIG. 5 is a schematic wiring diagram illustrating a manner of arrangement of light strings in light bundles according to an embodiment of the present invention.

FIG. 6 is the wiring diagram of FIG. 5, showing two controllers.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well known structures associated with decorative light strings and the individual light units thereof, have not been described in detail to avoid unnecessarily obscuring the descriptions of the embodiments of the invention.

Terms in the following description related to orientation such as “lower” and “upper,” “up” and “down,” and “left” and “right,” are only intended to describe the position or orientation of elements in relation to the figures in which they are illustrated, unless the context indicates otherwise.

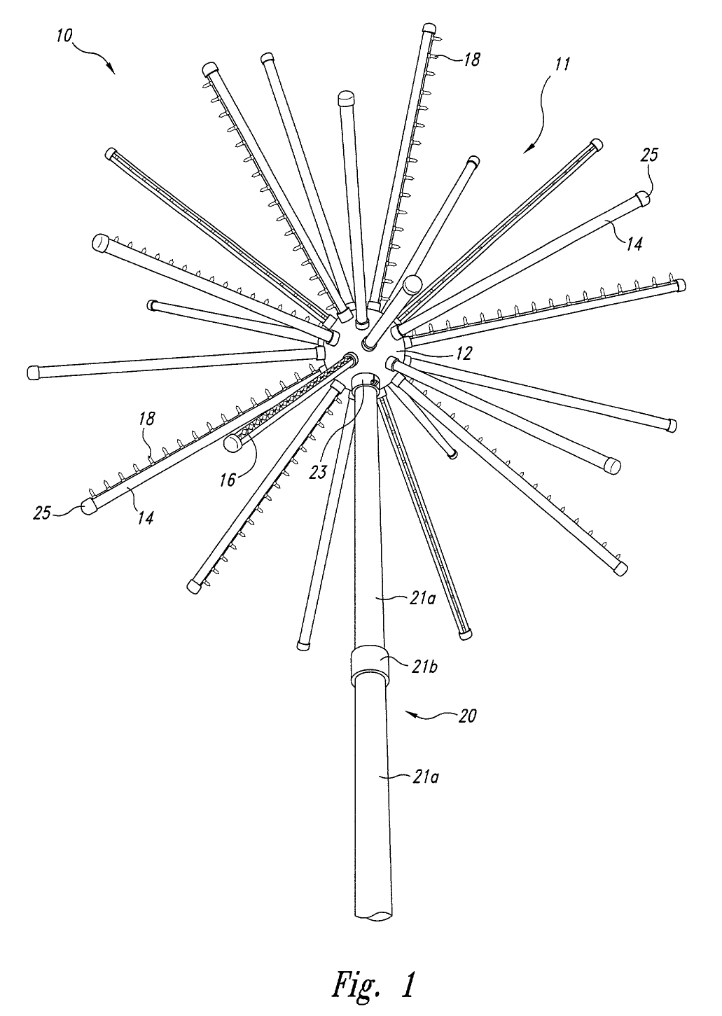

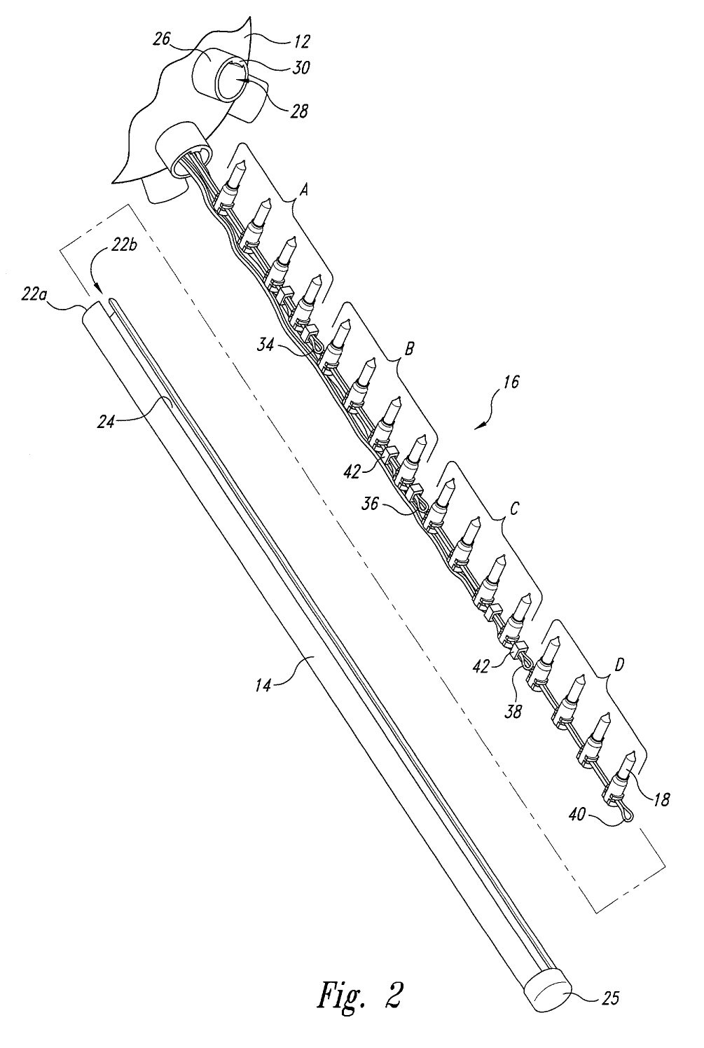

FIG. 1 shows an embodiment of a light system 10 of the present invention. In overview, the light system 10 comprises a light fixture 11 that includes a central member 12 in the shape of a sphere in the illustrated embodiment, and a plurality of elongated members, or retainer arms 14, that extend radially outward from the central member in a plurality of planes, forming a star-like configuration. Each retainer arm 14 is configured to retain one or more light strings (i.e. a plurality of light bulbs connected on a wire) or a plurality of light strings held together in a light bundle 16, such as that illustrated in FIG. 2. The bulbs 18 are disposed along the retainer arm 14 in a longitudinal row along the longitudinal axis of the retainer arm 14.

When power is supplied to the light system 10 to illuminate the bulbs 18, the overall arrangement of the light system and configuration of the light fixture 11 provides the appearance of rods or rays of light extending outwardly from a node in a plurality of directions, which can be reminiscent of a star with rays of light, or a burst of light from exploding fireworks. Also, in some embodiments a control system can be provided to allow the bulbs 18 (or groups of bulbs) on the light system 10 to turn on, and shut off, in a progressive chase sequence beginning from the innermost section of each retainer arm to the outermost section thereof. This can enhance the effect of the light system 10 in simulating explosions or fireworks displays. As will be appreciated by one skilled in the art after reviewing this disclosure, other control sequences can also be employed, in any of a variety of sequential orders.

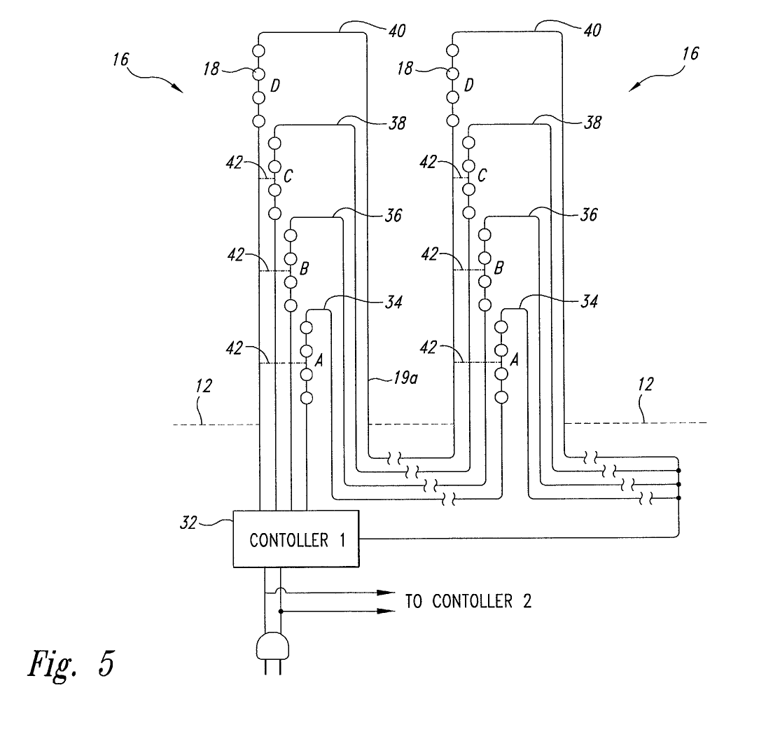

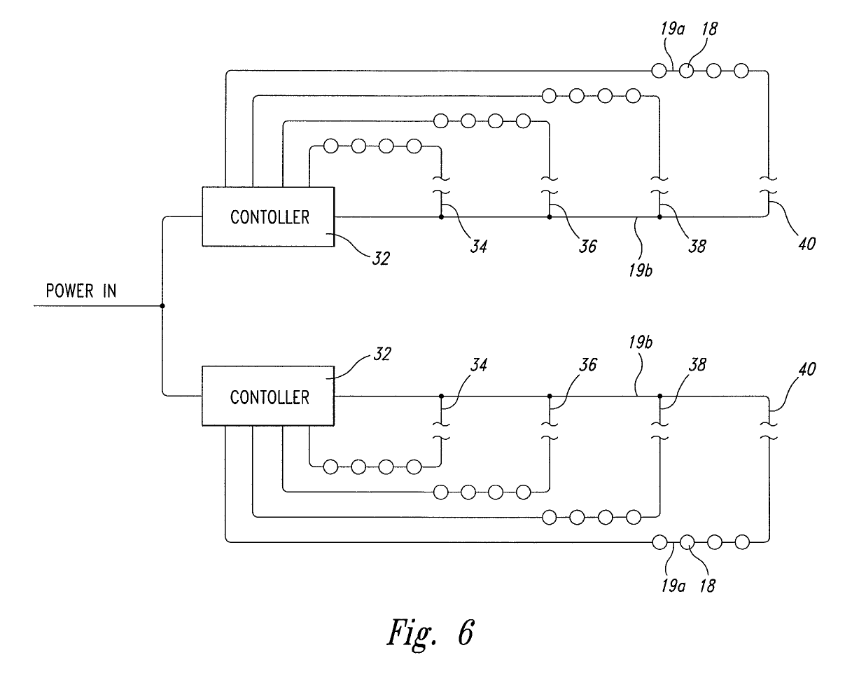

In some embodiments, the retainer arms 14 retain one or a plurality of light strings, while in other embodiments, the retainer arms retain light bundles 16 formed by a plurality of light strings tied together. FIGS. 2 and 5 illustrate one embodiment wherein light bundles 16 are employed. Before discussing the light bundles 16, an overview of the general wiring arrangement is provided. In some embodiments employing light bundles 16, two controllers 32 (FIG. 6) are contained within a cavity of the central member 12 for controlling two sets of parallel light strings 34, 36, 38, and 40. Both controllers can be powered through a single power cord that can be inserted into a power source, such as a standard wall outlet. FIG. 6 is an electrical diagram of one embodiment of the present invention showing the two controllers 32, each with plurality of parallel light strings 34, 36, 38, 40 connected thereto, with the controllers 32 also being connected in parallel to one another. Each of the light strings 34, 36, 38, 40 includes a wire 19a and bulbs 18. Also, each of the light strings is connected to a return wire 19b. In the embodiment illustrated in FIG. 6, four parallel light strings are connected to each controller 32, but other embodiments may include a higher or lower number of parallel light strings.

As illustrated in FIG. 5, each light string 34, 36, 38, 40 can have a plurality of bulb groups (e.g. groups of four bulbs in the illustrated embodiment) with the bulbs 18 being proximate one another in each bulb group, but with lengths of uninterrupted wire 19a between each bulb group. The light bundles 16, shown in FIGS. 2 and 5, are formed by tying or clipping sections of the light strings 34, 36, 38, 40 together using clips 42, with one bulb group from each light string tied into each light bundle 16, and with the bulb groups arranged linearly, in positions A-D. All of the bulb groups from each light string 34, 36, 38, and 40 can occupy the same position repeatedly throughout a plurality of light bundles 16. For example, the bulb groups of light string 40 can always be in position D for each light bundle 16, which is the furthest position from the central member 12 when the light bundles 16 are extended within the retainer arm 14 in a radial direction away from the central member 12. As one skilled in the art will appreciated upon reviewing this disclosure, this configuration involving repeated positioning of the bulb groups for each light string 34, 36, 38, and 40 facilitates controlling the lights in a chase sequence along the length of the retainer arms 14 (e.g. the controller can provide power to each parallel light string sequentially, one after the other, causing the bulbs 18 in positions A-D to turn on sequentially, one after the other).

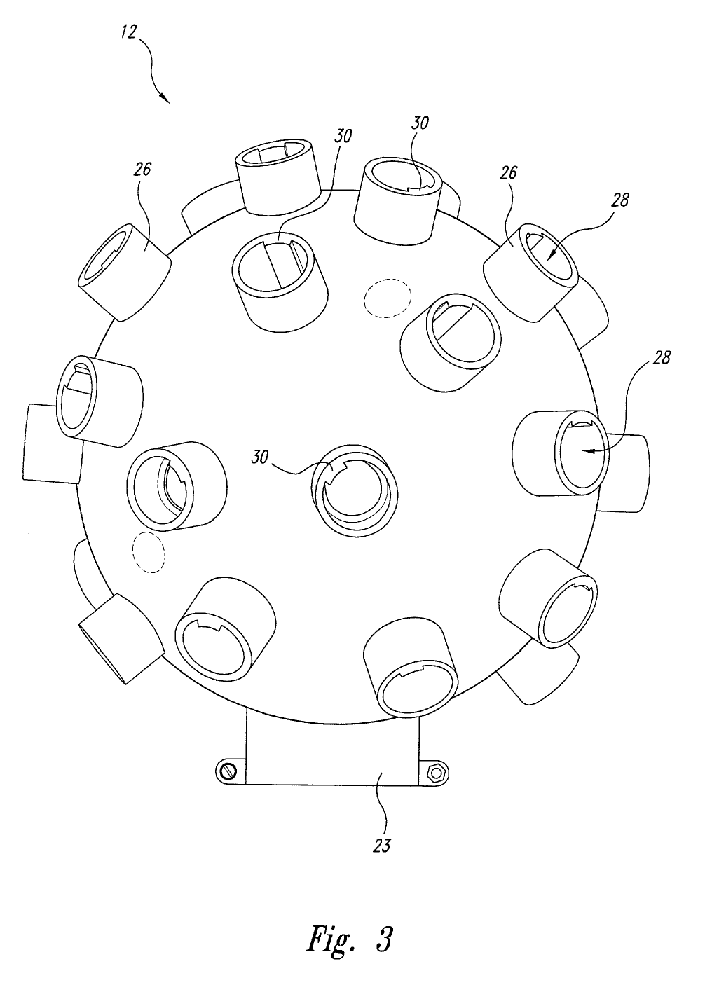

To enhance the aesthetic appeal of the light system 10, the wiring of the light bundles 16 (or light strings) can be substantially entirely concealed within the retainer arms 14 and central member 12. This can require routing wires directly from the controllers 32 inside the cavity of the central member 12 into the retainer arms 14 along the axes thereof to supply power to the bulbs 18, as well as returning the wires back from the retainer arms 14 directly into the cavity of the central member 12 before being routed back out of the sphere to another series of bulbs 18 held by another retainer arm, or returning the wires back to the controller as a return wire. In order to accomplish this, a plurality of wire-ways are formed on the sphere that lead directly into a proximal end 22a of the retainer arms 14, as best seen in FIGS. 2 and 3. These wire-ways can be hollow projections, or cylindrical members 26, formed on the surface of the central member 12 in equidistant spaced apart relation from one another. Each cylindrical member 26 has an interior sidewall defining an internal chamber therewithin that extends from the cavity of the central member 12 out to an annular opening 28 at an outer end of the cylindrical member. The light strings 34, 36, 38, 40, or light bundles 16, are routed in or out of the central member 12 through the internal chambers and annular openings 28 of the cylindrical members 26 and directly through a circular opening 22b at the proximal end 22a of the retainer arms 14, that faces the central member 12. As discussed in detail below, the circular opening 22b of the retainer arms 14 can be concealed within the cylindrical member 26 when the light system 10 is fully assembled, so that the wires are substantially completely concealed. Also, it is noted that unlike prior available light systems having elongated light members attached to a central member, the illustrated embodiment of the present invention does not require a break in the wires at the surface of the central member (i.e. no separable interface). Instead, the wires run directly from the internal cavity of the central member 12, out to the light bundles 16 that are retained within retainer arms 14, with no break in the wires therebetween.

The cylindrical members 26 also serve as coupling members for removably coupling the retainer arms 14 to the central member 12. That is, the proximal end portions 22a of the retainer arms 14 can be slidably inserted into the annular openings 28 to fit snuggly against the interior sidewalls of the cylindrical members 26, to releasably but securely retain the retainer arms 14 therewithin. There can be circumferential stop ridges (not shown) on the interior sidewalls of the cylindrical members 26 that prevent the retainer arms 14 from being inserted too far into the cylindrical members and into the cavity of the central member 12. Also, in some embodiments there can be a raised ridge 30, or radial projection, integrally formed on the interior sidewall of each cylindrical member 26. The raised ridge 30 is configured to be aligned within a portion of a slot 24 (discussed further below) formed on a corresponding retainer arm 14 so that when the retainer arm 14 is inserted in the cylindrical member 26, the raised ridge 30 extends inward through a portion of the slot 24. This engagement prevents the retainer arm 14 from rotating about its longitudinal axis. As discussed supra, the circular opening 22b can be concealed within the cylindrical member 26 so that the surface of the light fixture 11 is substantially continuous and uninterrupted (except for the slots 24, discussed below) to conceal the wiring of the light system.

As will be appreciated by one skilled in the art after reviewing this disclosure, the embodiments of the central member and wiring configurations disclosed above comprise unique central light systems that can be employed in a variety of the light systems in a variety of configurations. For example, the retainer arms coupled to the central member can take on a variety of shapes in addition to the linear shapes of the illustrated embodiments, and can be either uniform for the entire central member, or different, with each retainer arm having a unique shape. Also, various central light systems can be combined together to form other unique configurations.

FIG. 2 depicts one particular embodiment of the retainer arms 14 and light bundles 16. As can be seen, each retainer arm 14 can be tubular, with an interior sidewall defining an internal chamber of the retainer arm. The retainer arm 14 has an open proximal end 22a, with a circular opening 22b that faces the central member 12 as discussed above, as well as an opposite outer end, fitted with a cap 25 that covers an opening of the outer end. The aforementioned slot 24, or elongated opening, can extend along substantially the entire length of the retainer arm 14. In some embodiments, the slot 24 is contiguous with the circular opening 22b of the proximal end 22a. The light bundle 16 (or a light string 34,36,38,40) can be inserted through the circular opening 22b to extendedly retain the wires of the light bundle 16 in the internal chamber of the retainer arm 14, with the bulbs 18 arranged in a longitudinal row along the length of the slot 24 and with each bulb protruding past the sidewall of the retainer arm through the slot 24, as illustrated in FIG. 1. In some embodiments, the bulbs 18 projecting through the slot 24 can be replaced while the light bundle 16 (or light strings) is retained within the retainer arm 14 without removing the retainer arm from the central member 12.

The retainer arms 14 can be made of any material that is sufficiently rigid to support the light bundles 16 while maintaining the retainer arms 14 in substantially linear configuration regardless of the radial direction with which the retainer arms extend from the central member 12. In some embodiments, the retainer arms are made of plastic and the thickness of the retainer arm 14 walls can vary depending on the length and the weight of the retainer arm 14 and light bundles 16. Also, the retainer arms 14 can be translucent or opaque.

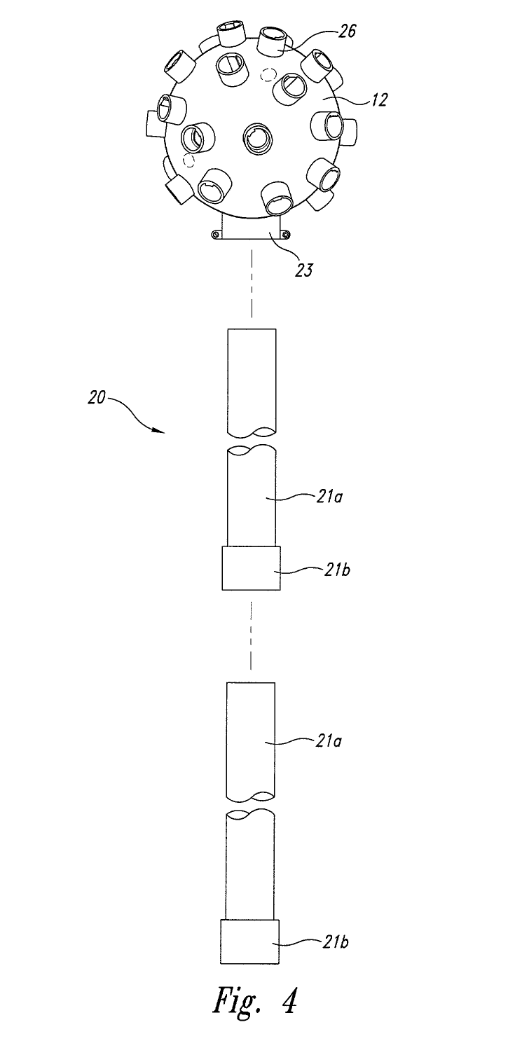

As best seen in FIGS. 1 and 4, the light fixture 11 can be provided with a mounting rod 20, or pole, that is releasably connectable to the central member 12 by inserting an upper end portion of the mounting rod 20 into an annular coupling stub 23 formed on the central member 12. The annular coupling stub 23 is sized to snuggly receive the upper end portion of the mounting rod 20. In addition, the mounting rod 20 can include a plurality of rod sections 21a that are releasably connectable to one another to allow the mounting rod to be disassembled for storage and transportation. In one embodiment, the rod sections 21a each have a coupling ring 21b fitted coaxially around a lower end of the rod section, and securely attached thereto. An extended portion of the coupling ring 21b extends downward past the lower end of the rod section. The extended portion is configured so that the upper end portion of another rod section 21a can be received therewithin and mated snuggly against the inside wall of the extended portion to connect the rod sections together. In this manner, any number of rod sections 21a having coupling rings 21b can be releasably connected together to form a mounting rod 20 of selectable length.

Furthermore, in some embodiments, a base platform is provided (not illustrated) to which the mounting rod 20 can be removably coupled. The base platform can be any shape and size sufficient to stably retain the mounting rod 20 in upright position with the central member 12 coupled to the top of the mounting rod 20. The base platform can also have a coupling member that is receivable within one of the extended portions of the coupling rings 21b to couple the base platform with a bottom rod section 21a of the mounting rod 20.

In yet another embodiment of the invention, the annular coupling stub 23 on the bottom of the central member 12 provides a wire-way and the rod sections 21b can each be hollow. The power cord for supplying power to the controllers 32 can thus be routed out of the central member 12 through the annular coupling stub 23 and down through the rod sections to be pulled out through an aperture (not shown) in one of the rod sections for connection to a power source.

Although specific embodiments and examples of the invention have been described supra for illustrative purposes, various equivalent modifications can be made, without departing from the spirit and scope of the invention, as will be recognized by those skilled in the relevant art after reviewing the present disclosure. For example, the light fixture 11 could be hung from above by a cord. The various embodiments described can be combined to provide further embodiments. The described devices and methods can omit some elements or acts, can add other elements or acts, or can combine the elements or execute the acts in a different order than that illustrated, to achieve various advantages of the invention.

In general, in the following claims, the terms used should not be construed to limit the invention to the specific embodiments disclosed in the specification. Accordingly, the invention is not limited by the disclosure, but instead its scope is determined entirely by the following claims.

1. A light fixture for use in combination with at least one light string having a plurality of light bulbs, the light fixture comprising:
a central member; and
a plurality of elongated members coupled to the central member and projecting outwardly from the central member in a respective plurality of radial directions, each elongated member having a sidewall defining an internal chamber and a first opening located proximate the central member for receiving a portion of the at least one light string, and each elongated member having at least a second opening sized and shaped to allow at least one light bulb to project outwardly through the sidewall of the elongated member.

2. The light fixture of claim 1, further comprising a base configured to support the light fixture on a solid surface.

3. The light fixture of claim 1, further comprising a base configured to support the light fixture on a solid surface, and a rod coupled between the base and the central member to space the central member apart from the solid surface.

4. The light fixture of claim 1 wherein the central member is at least substantially spherical in shape.

5. The light fixture of claim 1 wherein the elongated members are removably coupled to the central member.

6. The light fixture of claim 1 wherein the elongated members are made from a material that is not translucent.

7. The light fixture of claim 1 wherein the elongated members are sufficiently rigid to remain substantially linear when used to support the at least one light string.

8. The light fixture of claim 1 wherein the plurality of radial directions are collectively non-planar.

9. The light fixture of claim 1 wherein the central member comprises a plurality of coupling members configured to releasably retain the respective plurality of elongated members.

10. The light fixture of claim 1 wherein the central member comprises a plurality of first coupling members and the elongated members each comprise a complementary second coupling member such that the elongated members can be selectively engaged with and disengaged from the central member.

11. The light fixture of claim 1 wherein the central member comprises a plurality of projections each configured to slidably engage one of the elongated members.

12. The light fixture of claim 1 wherein the central member comprises a plurality of projections, each projection having an internal wall sized to slidably receive a proximal end of one of the elongated members.

13. The light fixture of claim 1 wherein the first opening in the elongated member is in an end of the elongated member such that the internal chamber in the elongated member directly communicates with the central member.

14. The light fixture of claim 1 wherein the central member has an internal cavity for retaining at least a portion of the at least one light string, and wherein the first opening in the elongated member is in an end of the elongated member, such that the internal chamber in the elongated member directly communicates with the central member to allow a portion of the at least one light string to be routed directly from the central member into the elongated member.

15. The light fixture of claim 1 wherein the second opening in the elongated member is an elongated slot allowing a plurality of light bulbs to project outwardly from the elongated member along a length of the elongated member.

16. The light fixture of claim 1 wherein the first opening is contiguous with the second opening.

17. The light fixture of claim 1 wherein the second opening in the elongated member is an elongated slot extending along substantially an entire length of the elongated member, and wherein the central member comprises a plurality of annular projections, each annular projection having a wall sized to slidably receive a proximal end of one of the elongated members, the wall of each annular projection having a radial projection engaged with the slot in the elongated member to prevent the elongated member from rotating with respect to the annular projection.

18. A light system comprising:
a central member;
a plurality of elongated members coupled to the central member and projecting outwardly from the central member in a respective plurality of radial directions, each elongated member having a sidewall defining an internal chamber, a first opening located proximate the central member, and a second opening have at least a portion located distally along the elongated member with respect to the first opening; and
at least one light string extending at least partially into each of the elongated members, the at least one light string comprising a plurality of light bulbs, with at least one light bulb projecting outwardly through the second opening of each elongated member.

19. The light system of claim 18 wherein the central member has an internal cavity, and wherein at least a portion of the at least one light string is routed through the internal cavity.

20. The light system of claim 18 wherein the central member has an internal cavity, and wherein the first opening in the elongated member is in an end of the elongated member such that the at least one light string can pass directly from the central member to the elongated member.

21. The light system of claim 18 wherein the at least one light string is routed sequentially into and out of a plurality of the elongated members.

22. The light system of claim 18 wherein the central member has an internal cavity, and wherein the at least one light string is routed alternatingly between the internal cavity and one of the elongated members, until the at least one light string is routed into at least about half of the elongated members coupled to the central member.

23. The light system of claim 18 wherein the central member has an internal cavity, and wherein the at least one light string is routed alternatingly between the internal cavity and one of the elongated members, until the at least one light string is routed into all of the elongated members coupled to the central member.

24. The light system of claim 18, further comprising a control unit, and wherein the at least one light string comprises a plurality of light strings, the plurality of light strings being controlled by the control unit to be illuminated in a desired sequence.

25. The light system of claim 18, further comprising a control unit, and wherein the at least one light string comprises a plurality of light strings, each of the plurality of light strings being routed through a portion of each of the elongated members such that the light bulbs collectively extend along at least substantially the entire length of each of the elongated members, the plurality of light strings being controlled by the control unit to be illuminated in a desired sequence along the lengths of the elongated members.

26. The light system of claim 18 further comprising at least one control unit disposed within an internal cavity of the central member and wherein the at least one light string comprises a plurality of light strings with each of the plurality of light strings being routed alternatingly between the internal cavity and one of the elongated members until the bulbs of the light strings collectively extend along at least substantially the entire length of each of the elongated members.

27. The light system of claim 26 wherein the plurality of light strings are controlled by the control unit to be illuminated in a desired sequence along the lengths of the elongated members.

28. The light system of claim 18 wherein the at least one light string comprises a plurality of light strings and further comprising a control unit configured to illuminate the bulbs of the respective light strings in a desired order, and with each of the plurality of light strings being routed through at least a portion of each of the elongated members, the light bulbs of each of the respective light strings occupying a repeated position in each of the elongated members.

29. The light system of claim 28 wherein the light strings within each elongated member are bound together to form a light bundle.

30. A light system comprising:
a central member;
a plurality of elongated members independently coupled to the central member and projecting outwardly from the central member in a respective plurality of radial directions, with each elongated member having a sidewall defining an internal chamber and with each elongated member having one or more openings in its sidewall, the one or more openings extending along a length of the elongated member;
a plurality of light strings, each light string being routed into each of the elongated members with each light string comprising a plurality of light bulbs, and with at least one light bulb from each light string projecting outwardly through the opening in each elongated member; and
a control unit configured to sequentially activate and deactivate the light strings to illuminate the light bulbs along the elongated members in a desired sequence.

31. The light system of claim 30 wherein each light string comprises a continuous wire such that there exists no breaks in the light strings between the elongated members.

32. The light system of claim 30 wherein the central member comprises an internal cavity, and wherein each light string comprises a continuous wire sequentially extending between the internal cavity and each of the plurality of elongated members.

33. A method for fabricating a light system, comprising:
routing a plurality of parallel light strings through a hollow central member having a plurality of openings thereon, such that a portion of each light string with at least one light bulb attached thereto projects out of each of the plurality of openings;
providing an elongated member for each opening, and inserting the portions of each light string projecting out of each opening into the elongated member provided for the opening, the elongated members having a perforated sidewall such that the respective light bulbs project out of the elongated members and collectively extend along a length of the elongated members; and
coupling the elongated members to the hollow central member such that the elongated members project outward from the hollow central member in a respective plurality of radial directions.

34. The method of claim 33 wherein each of the light strings comprises a continuous wire, and wherein routing the plurality of parallel light strings comprises sequentially routing the continuous wires out of and back into each of the openings in the hollow central member.

35. The method of claim 33 wherein inserting the portions of light strings into the elongated members provided for the respective openings comprises sequentially inserting the portions of light strings with the light bulbs from the respective light strings projecting out of the elongated member along a distinct portion of the length of the elongated member.

36. The method of claim 33 further comprising bundling the portions of light strings projecting out of each opening together to form light bundles, with each portion of each respective light string occupying a repeated position in each light bundle along a length of the light bundle.

37. The method of claim 33 wherein each elongated member comprises at least one elongated slot extending along its length, and wherein inserting the portion of light strings into the elongated member comprises sliding the light string into the elongated member with the light bulb projecting out of the slot.

38. The method of claim 33 wherein the hollow central member comprises first couplings and each of the elongated members comprises a complementary second coupling, and wherein coupling the elongated members to the hollow central member comprises engaging the first couplings with the corresponding second couplings.

39. The method of claim 33 wherein the hollow central member comprises a plurality of annular projections, and wherein coupling the elongated members to the hollow central member comprises engaging the elongated members with the corresponding annular projections.

40. The method of claim 33 wherein the hollow central member comprises a plurality of annular projections, each annular projection having a radial locking member and each elongated member having a complementary recess, and wherein coupling the elongated members to the hollow central member comprises engaging the elongated members with the corresponding annular projections such that the recess on the elongated member captively receives the locking member to prevent the elongated member from rotating with respect to the central member.

41. A central lighting system for use with a plurality of light retainer arms, the central lighting system comprising:
a central member having a plurality of wire-ways and an internal cavity;
a light string controller disposed within the internal cavity of the central member; and
a plurality of parallel light strings electrically connected to the controller, each of the parallel light strings having a plurality of bulb groups connected to the light string at intervals along the light string, each light string being routed out of each wire-way and back into the central member through each respective wire way with at least one bulb group from each light string being disposed outside of each wire-way and with at least two of the bulb groups outside of each wire-way being bound together to form a collectively longer row of bulbs.
